(19) United States
(12) Patent Application Publication
(10) Pub. No.: US 2012/0018920 A1
(43) Pub. Date: Jan. 26, 2012

(54) RESIN SUPPLY DEVICE AND METHOD FOR MANUFACTURING SEMICONDUCTOR DEVICE

(75) Inventors: Koji OGISO, Kanagawa-ken (JP); Taku Kamoto, Kanagawa-ken (JP)

(73) Assignee: Kabushiki Kaisha Toshiba, Tokyo (JP)

(21) Appl. No.: 13/180,928

(22) Filed: Jul. 12, 2011

(30) Foreign Application Priority Data
Jul. 26, 2010 (JP) 2010-167581

(51) Int. Cl. B29C 31/10

(52) U.S. Cl. 264/272.14; 425/116

(57) ABSTRACT

According to one embodiment, a resin supply device is configured to supply granular resins to a resin mold device including a first mold provided with a cavity and a second mold mated to the first mold. The resin supply device includes a first mechanism and a second mechanism. The first mechanism is configured to juxtapose multiple granular resins on an adsorption surface by adsorbing the multiple granular resins on the adsorption surface larger than the granular resins, and form an adsorbed resin body with a uniform thickness. The adsorbed resin body is made of the adsorbed multiple granular resins on the adsorption surface. The second mechanism is configured to drop the multiple granular resins adsorbed on the adsorption surface into the cavity by adsorption-release of the adsorption surface.

### CROSS-REFERENCE TO RELATED APPLICATIONS

This application is based upon and claims the benefit of priority from the prior Japanese Patent Application No. 2010-167581, filed on Jul. 26, 2010; the entire contents of which are incorporated herein by reference.

### FIELD

Embodiments described herein relate generally to a resin supply device and a method for manufacturing a semiconductor device.

### BACKGROUND

There exists a resin seal device including an upper mold and a lower mold facing the upper mold as a device sealing a chip-shaped electronic part with a resin. If the lower mold and the upper mold of such a resin seal device are mated, a cavity is formed therebetween. The electronic part is sealed in the cavity with a sealing resin.

A method for supplying the sealing resin into the cavity includes a method in which a granular sealing resin is only placed at the center of the lower mold or a method in which the granular sealing resin is dropped into the cavity from a resin supply port provided on the upper mold through a diffuser. However, even if the sealing resin is supplied into the cavity by these methods, its layer thickness distribution is fluctuated. Thereby, the sealing resin does not reach a cavity end at time of compression molding of the sealing resin, unfilled portions and voids may occur in the mold resin containing the electronic part after compression molding. Moreover, at the compression molding, the melted sealing resin flows in the cavity and the electronic part may be damaged by a flow pressure of the sealing resin.

In contrast, there exists a method in which a shooter supplying the sealing resin houses the diffuser therein and the sealing resin is supplied into the cavity from the shooter while dispersing the granular sealing resin by the diffuser. However, even though methods like this, when particle diameter of the sealing resin is fluctuated, the sealing resin is difficult to be dispersed substantially uniform in the cavity.

### BRIEF DESCRIPTION OF THE DRAWINGS

FIGS. 1A and 1B are schematic views of the relevant part of a resin supply device according to a first embodiment, FIG. 1A shows an upper surface schematic view of the relevant part, and FIG. 1B shows a cross-sectional view of the relevant part at an X-Y position in FIG. 1A;

FIGS. 2A to 2C are schematic cross-sectional views of the relevant part of a method for manufacturing a semiconductor device according to the first embodiment;

FIGS. 3A and 3B are schematic cross-sectional views of the relevant part of a method for manufacturing a semiconductor device according to the first embodiment;

FIGS. 4A and 4B are schematic cross-sectional views of the relevant part of a method for manufacturing a semiconductor device according to the first embodiment;

FIGS. 5A and 5B are schematic cross-sectional views of the relevant part of a method for manufacturing a semiconductor device according to the first embodiment;

FIGS. 6A and 6B are schematic views of the relevant part of a resin supply device according to a second embodiment, FIG. 1A shows an upper surface schematic view of the relevant part, and FIG. 1B shows a cross-sectional view of the relevant part at an X-Y position in FIG. 6A;

FIGS. 7A and 7B are views describing the operation of a resin supply device according to the second embodiment; and

FIGS. 8A and 8B are schematic views of the relevant part of a resin supply device according to a second embodiment, FIG. 1A shows an upper surface schematic view of the relevant part, and FIG. 1B shows a cross-sectional view of the relevant part at an X-Y position in FIG. 8A.

### DETAILED DESCRIPTION

In general, according to one embodiment, a resin supply device is configured to supply granular resins to a resin mold device including a first mold provided with a cavity and a second mold mated to the first mold. The resin supply device includes a first mechanism and a second mechanism. The first mechanism is configured to juxtapose multiple granular resins on an adsorption surface by adsorbing the multiple granular resins on the adsorption surface larger than the granular resins, and form an adsorbed resin body with a uniform thickness. The adsorbed resin body is made of the adsorbed multiple granular resins on the adsorption surface. The second mechanism is configured to drop the multiple granular resins adsorbed on the adsorption surface into the cavity by adsorption-release of the adsorption surface.

In general, according to one embodiment, a method is disclosed for manufacturing a semiconductor device using a resin mold device including a first mold provided with a cavity and a second mold mated to the first mold. The method can include juxtaposing multiple granular resins on an adsorption surface by adsorbing the multiple granular resins on the adsorption surface of a resin supply device, and forming an adsorbed resin body with a uniform thickness. The adsorbed resin body is made of the adsorbed multiple granular resins on the adsorption surface. The method can include opposing the first mold to the adsorption unit to drop the multiple granular resins into the cavity of the first mold by adsorption-release of the adsorption surface. In addition, the method can include after melting the multiple granular resins, mating the second mold to the first mold to immerse semiconductor chips attached to the second mold into the melted granular resins. The resin supply device is configured to supply the granular resins to the resin mold device including the first mold provided with the cavity and the second mold mated to the first mold. The resin supply device includes a first mechanism and a second mechanism. The first mechanism is configured to juxtapose the multiple granular resins on the adsorption surface by adsorbing the multiple granular resins on the adsorption surface larger than the granular resins, and form the adsorbed resin body with the uniform thickness. The adsorbed resin body is made of the adsorbed multiple granular resins on the adsorption surface. The second mechanism is configured to drop the multiple granular resins adsorbed on the adsorption surface into the cavity by the adsorption-release of the adsorption surface.

Various embodiments will be described hereinafter with reference to the accompanying drawings.

### First Embodiment

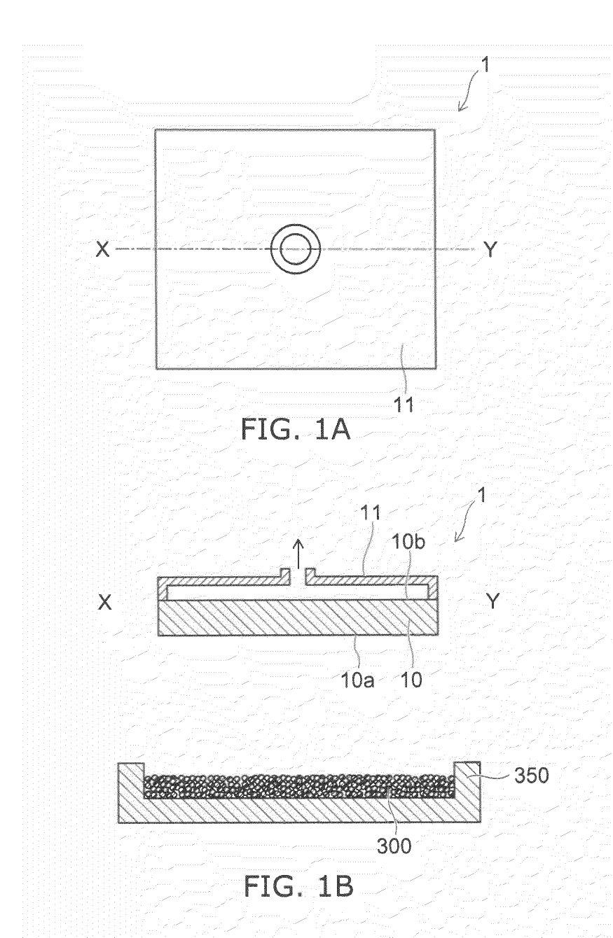

FIGS. 1A and 1B are schematic views of the relevant part of a resin supply device according to a first embodiment, FIG. 1A shows an upper surface schematic view of the relevant part, and FIG. 1B shows a cross-sectional view of the relevant part at an X-Y position in FIG. 1A. FIG. 1B illustrates a vessel 350 with a resin supply device 1. The vessel is filled with a granular sealing resin (granular resin) 300.

The resin supply device 1 includes an adsorption unit 10 and a suction section 11 attached to the adsorption unit 10. The adsorption unit 10 is made of a porous block body or plate. A first major surface 10a of the adsorption unit 10 faces the vessel 350. An area of the first major surface 10a is greater than an average particle diameter of the granular sealing resin 300. The first major surface 10a serves as an adsorption surface of multiple granular sealing resins 300. The suction section 11 is attached to a second major surface 10b of the adsorption unit 10. The first major surface 10a is generally parallel to the second major surface 10b.

Material of the adsorption unit 10 is, for example, porous ceramic, activated charcoal, glass fiber, paper, cloth, and foam polystyrene and the like. The porous ceramic includes illustratively ceramic sintered body, pumice and the like including silica gel, silicon oxide (SiO₂), silicon carbide (SiC) and the like as main components. Innumerable paths having holes communicating three-dimensionally are arranged inside the adsorption unit 10. These paths include a number of paths communicating between the first major surface 10a and the second major surface 10b of the adsorption unit 10.

The inside of the suction section 11 is, for example, pressure-reduced by a vacuum pump (not shown) connected to the suction section 11 or pressure-increased over an atmospheric pressure. The resin supply device 1 is capable of adsorbing multiple granular sealing resins 300 onto the adsorption unit 10.

Next, a semiconductor device according to the first embodiment is described with description of the operation of the resin supply device 1.

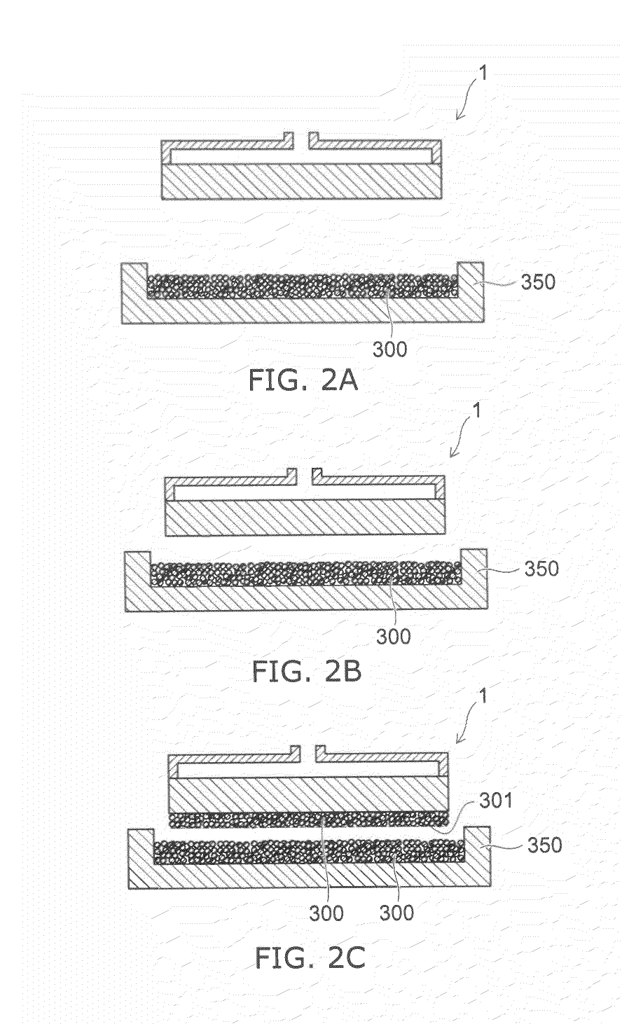

FIGS. 2A to 5B are schematic cross-sectional views of the relevant part of a method for manufacturing the semiconductor device according to the first embodiment.

First, as shown in FIG. 2A, the first major surface 10a of the adsorption unit 10 of the resin supply device 1 is opposed to the multiple granular sealing resins 300 filled in the vessel 350. The granular sealing resin 300 is, for example, a relatively large granular sealing resin such as a granule, or a relatively small granular sealing resin such as a powder. Material of the granular sealing resin 300 is, for example, a thermosetting epoxy resin. The material of the granular sealing resin 300 is not limited to the thermosetting epoxy resin.

Next, as shown in FIG. 2B, the first major surface 10a of the adsorption unit 10 of the resin supply device 1 is approximated to a surface of the multiple granular sealing resins 300. Alternatively, the first major surface 10a of the adsorption unit 10 may be in contact with the surface of the multiple granular sealing resins 300.

Next, as shown in FIG. 2C, the suction section 11 of the resin supply device 1 is put into a pressure-reduced state. The maximum width of respective apertures provided in the adsorption unit 10 is designed to be smaller than an average particle diameter of the granular sealing resins 300. The average particle diameter of the granular sealing resins 300 is in a range from 300 μm (micrometer) to 500 μm. The average particle diameter is a value determined by one of an image analysis method, a light shielding method, Coulter method, a precipitation method and a laser diffraction scattering method. The maximum width of the aperture provided in the adsorption unit 10 is, for example, 150 μm or less.

If the suction section 11 is put into the pressure-reduced state, an air flow is generated from the first major surface 10a of the adsorption unit 10 to the second major surface 10b. At this time, if the multiple granular sealing resins 300 adhere to the first major surface 10a of the adsorption unit 10 in a layered configuration, the air flow from the first major surface 10a to the second major surface 10b is suppressed.

Consequently, the inside of the adsorption unit 10 is put into the pressure-reduced state, and the granular sealing resins 300 being in contact with the first major surface 10a of the adsorption unit 10 adsorbs on the first major surface 10a of the adsorption unit 10.

That is, the adsorption unit 10 functions as a filter of the sealing resins 300 and the multiple granular sealing resins 300 are vacuum-adsorbed on the first major surface 10a of the adsorption unit 10.

In this manner, the multiple granular sealing resins 300 adsorb on the first major surface 10a being an adsorption surface to be juxtaposed on the adsorption surface. An adsorbed resin body 301 with a uniform thickness made of the adsorbed multiple granular sealing resins 300 is formed on the adsorption surface.

In other words, the granular sealing resins 300 adsorbed on the first major surface of the adsorption unit 10 are not limited to a monolayer. For example, the multiple granular sealing resins 300 adsorb two-dimensionally in the first major surface 10a and furthermore adsorb three-dimensionally on the first major surface 10a. That is, the adsorbed resin body 301 with a generally uniform thickness is formed on the first major surface 10a of the adsorption unit 10.

A distribution of the layer thickness on the first major surface 10a of the adsorbed sealing resins 300 does not depend on the average particle diameter of the multiple granular sealing resins 300 and is generally uniform. A distribution of the layer thickness on the first major surface 10a of the adsorbed sealing resins 300 does not depend on the layer thickness of the multiple granular sealing resins 300 and is generally uniform. The layer thickness of the adsorbed multiple granular sealing resins 300 is controlled by combination of vacuum pressure in the suction section 11 and the width (diameter) of the aperture in the adsorption unit 10. For example, with lowering pressure in the suction section 11 or increasing width of the aperture in the adsorption unit 10, a suction force by the adsorption surface increases, and the granular sealing resins 300 with a thicker thickness can be adsorbed on the adsorption surface.

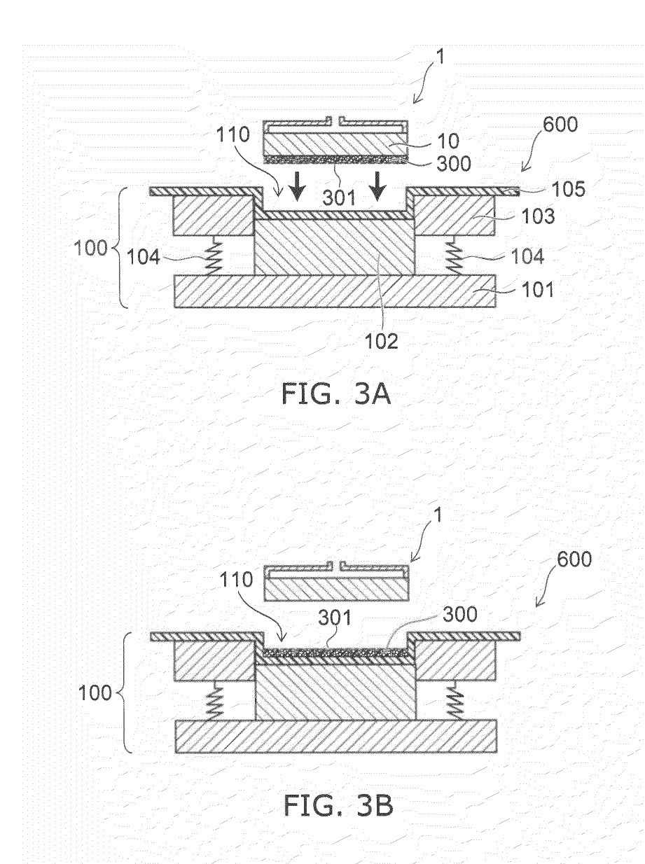

Next, as shown in FIG. 3A, the adsorption unit 10 of the resin supply device 1 on which the multiple granular sealing resins 300 adsorb is opposed to a lower mold (first mold) 100 of a resin mold device 600.

The lower mold 100 includes a fixed platen 101, a support mounting 102 provided on the fixed platen 101 and a movable ring 103 provided on a periphery of the support mounting 102. An elastic body 104 such as a spring and the like is provided between the movable ring 103 and the fixed platen 101. In addition, the lower mold 100 is provided with a cavity 110.

When the movable ring 103 of the lower mold 100 is pushed to the fixed platen 101 side, restoring force of the elastic body 104 generates force to cause the movable ring 103 to separate from the fixed platen 101. In addition, the lower mold 100 is provided with a heating mechanism (not shown).

A film 105 for releasing the molded product is disposed on a surface of the support mounting 102 and a surface and a side face of the movable ring 103. Subsequently, as shown by arrows, the adsorbed sealing resins 300 are approximated to a bottom face of the cavity 110 of the lower mold 100. Thus the surface of the support mounting 102 is a bottom face of the cavity 110 and the side face of the movable ring 103 is a side face of the cavity 110.

Next, as shown in FIG. 3B, the pressure of the suction section 11 of the resin supply device 1 is increased more than the atmospheric pressure. When the pressure of the suction section 11 is increased more than the atmospheric pressure, vacuum-adsorption of the sealing resins 300 through the adsorption unit 10 is released. Thus, the sealing resins 300 which have been adsorbed on the first major surface 10a of the adsorption unit 10 drops directly into the cavity 110 under one's own weight. That is, in the resin supply device 1, while facing the adsorption unit 10 to the lower mold 100, the multiple granular sealing resins 300 (above adsorbed resin body 301) can be dropped (supplied) into the cavity 110 by adsorption-release of the first major surface 10a (adsorption surface).

Since the layer thickness distribution of the sealing resins 300 adsorbed on the first major surface 10a of the adsorption unit 10 is generally uniform, the layer thickness of the sealing resins 300 supplied into the cavity 110 is generally uniform in the cavity 110. That is, the layer distribution of the supplied sealing resins 300 in the cavity 110 does not depend on the average particle diameter of the multiple granular sealing resins 300 and is generally uniform. The layer distribution of the supplied sealing resins 300 in the cavity 110 does not depend on the layer thickness of the multiple granular sealing resins 300 and is generally uniform.

In this manner, according to the first embodiment, the layer thickness of the multiple granular sealing resins 300 supplied into the cavity 110 has generally uniform distribution.

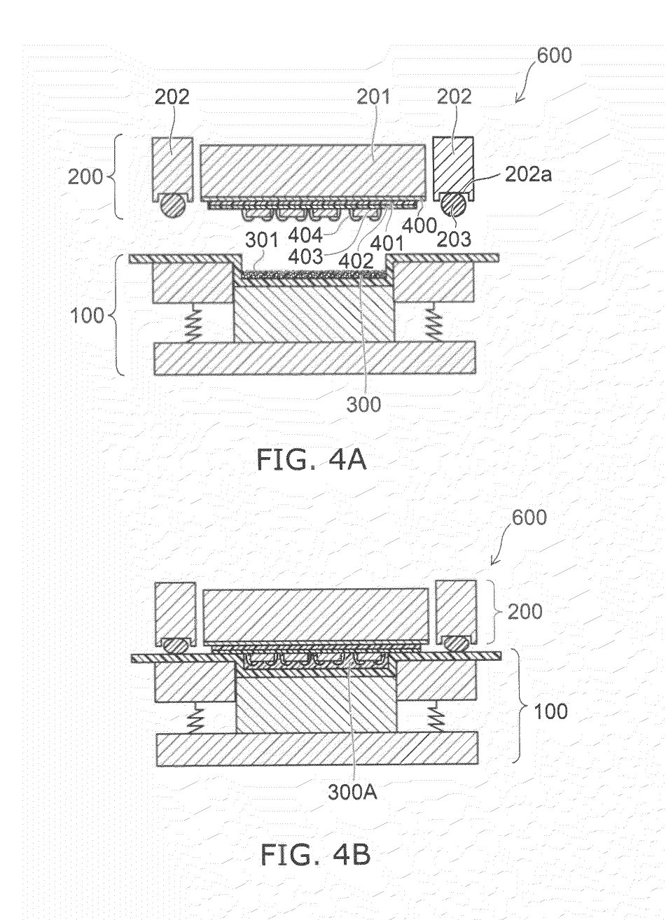

Next, as shown in FIG. 4A, an upper mole (second mold) 200 of the resin mold device 600 is opposed to the lower mold. The upper mold 200 and the lower mold 100 mate each other.

The upper mold 200 includes a support mounting 201, a circumference block 202 provided on a periphery of the support mounting 201. An recess 202a is provided on the circumference block 202. A seal material 203 is placed in the recess 202a. In addition, the upper mold 200 is provided with a heating mechanism (not shown).

A support substrate 400 is attached to a major surface of the support mounting 201 facing the lower mold. A printed substrate (interposer) 402 is provided on the support substrate 400 via an adhesion layer 401. Multiple semiconductor chips 403 are installed on a printed substrate 402.

The semiconductor chips 403 are semiconductor chips in a wafer state. Active elements such as a transistor or the like and passive elements such as a resistance and a capacitance or the like are disposed on a semiconductor substrate surface such as silicon (Si) or the like. Bonding wires 404 are extracted from the semiconductor chips 403 and connected with the printed substrate 402.

The semiconductor chips 403, the bonding wires 404 and the printed substrate 402 are preliminarily attached to the upper mold 200. Therefore, even if the multiple granular sealing resins 300 are dropped into the cavity 110, the semiconductor chips 403, the bonding wires 404 and the printed substrate 402 are not damaged by the drop shock.

Next, after the heating mechanism of the lower mold 100 is operated and the multiple granular sealing resins 300 are melted, the lower mold 100 and the upper mold 200 are mated. Thus, the semiconductor chips 403 and the bonding wires 404 are immersed into the melted sealing resins 300. Furthermore, the lower mold 100 and the upper mold 200 compresses the sealing resins 300. This state is shown in FIG. 4B.

Here, the lower mold 100 or the upper mold 200 is set at a temperature at which the sealing resins 300 are thermally cured. After a prescribed time, the melted sealing resins 300 are thermally cured in the cavity 110. Thereby, the respective semiconductor chips 403 and the bonding wires 404 are sealed in a mold resin 300A.

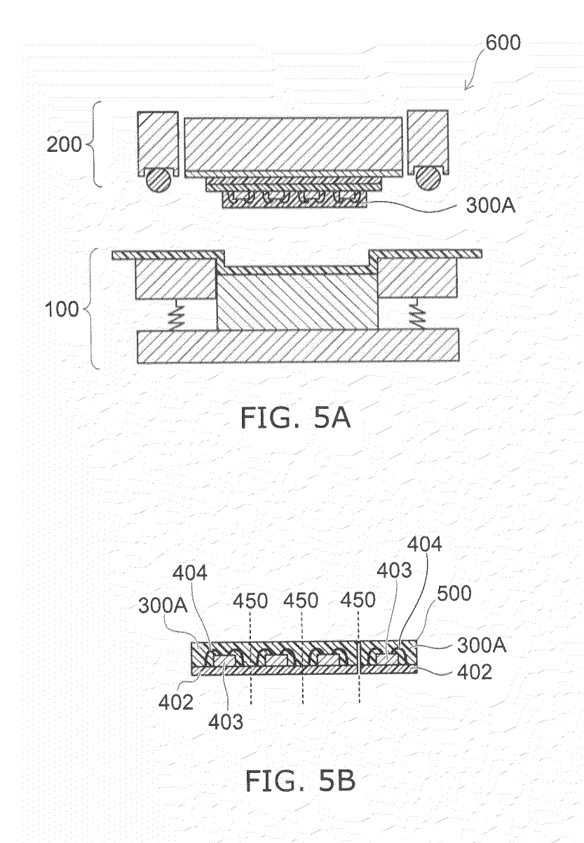

Next, as shown in FIG. 5A, the lower mold 100 and the upper mold 200 are separated and the compression to the mold resin 300A is released. Subsequently, after the mold resin 300A and the printed substrate 402 are removed from the lower mold 100, as shown in FIG. 5B, the mold resin 300A and the printed substrate 402 are cut along dicing lines 450.

After individualizing the mold resin 300A and the printed substrate 402, a semiconductor device 500 of CSP (Chip Size Package) type is formed. The semiconductor chip 403 in a wafer state of the semiconductor device 500 is sealed in the mold resin 300A.

In this manner, the resin supply device 1 includes a first mechanism and a second mechanism. The first mechanism is capable of juxtaposing the multiple granular resins on the adsorption surface by adsorbing the multiple granular resins 300 on the adsorption surface larger than the granular resins 300, and forming the adsorbed resin body 301 with the uniform thickness made of the adsorbed multiple granular resins 300 on the adsorption surface. The second mechanism is capable of dropping the multiple granular resins 300 adsorbed on the adsorption surface into the cavity 110 by adsorption-release of the adsorption surface.

In the embodiment, before the resin formation, the multiple granular resins 300 are supplied into the cavity 110 of the lower mold 100 so as to form a layer with the generally uniform distribution. Thereby, the multiple granular sealing resins 300 are supplied evenly over the whole area of the cavity 110. Therefore, the resin flow in the cavity 110 is suppressed during the resin formation. As a result, deformation and breaking of the bonding wires 404, and contact between the bonding wires 404 are hard to occur. Even though the CSP type semiconductor device 500 is formed, a thickness of the mold resin 300A is uniform. Therefore, fabrication yield of the semiconductor device 500 is improved.

In the embodiment, resin sealing is performed without placing diffuser such as a net or the like between the sealing resins 300 adsorbed on the adsorption unit 10 and the cavity 110 of the lower mold 100.

For example, a comparative example includes a method of placing the diffuser such as a net or the like on the cavity 110 of the lower mold 100 and supplying the multiple granular sealing resins 300 into the cavity 110 via the diffuser. However, in the method like this, the distribution of the layer thickness of the sealing resins 300 becomes easy to be fluctuated by influence of shape of the diffuser. This tendency is more prominent with decreasing layer thickness of the sealing resins 300 supplied into the cavity 110 (for example, prominent in a layer thickness of 300 μm or less.

Alternatively, another comparative example includes a method of housing a coil-shaped diffuser inside a tube-shaped shooter, once dispersing the granular sealing resins in the shooter by the diffuser, and supplying the multiple granular sealing resins 300 from the shooter into the cavity 110. However, in the case where the diameter of the multiple granular sealing resins 300 is scattered in a prescribed range, degree of bounce of the sealing resins to the diffuser and an inner wall of the shooter is different depending on the respective particle diameters. Therefore, if the multiple granular sealing resins 300 are supplied into the cavity 110 using the shooter housing the diffuser, the distribution of the layer thickness of the supplied sealing resins 300 in the cavity may be non-uniform. When using the tube-shaped shooter, an area available for supplying the multiple granular sealing resins 300 may be limited and the resin sealing over a broad area may be difficult.

Moreover, in the resin supply method based on the shooter, the sealing resins 300 are supplied into the cavity 110, while the granular sealing resins 300 are being splashed from the shooter. Therefore, the size of the particle diameter of the sealing resins 300 may be fluctuated.

Moreover, in the resin supply method based on the shooter, since the sealing resins 300 collide against the inner wall of the shooter, the diffuser or the like, the sealing resins 300 may break up and the broken up resins may turn to be powder dust to soar around the resin mold device. This contaminates the resin mold device. Contrarily, in the embodiment, breaking up of the sealing resins 300 and soaring of the powder dust are hardly to occur.

In the resin supply method based on the shooter, the distribution of the layer thickness of the sealing resins 300 becomes easy to be fluctuated under influence of the shape of the housed diffuser and the shooter diameter. This tendency is more prominent with decreasing layer thickness of the sealing resins 300 supplied into the cavity 110 (for example, prominent in a layer thickness of 300 μm or less.

Contrarily, in the embodiment, the sealing resins 300 adsorbed on the adsorption unit 10 is directly dropped into the cavity 110 to be supplied. Therefore, the diffuser pattern is not reflected to the distribution of the layer thickness of the sealing resins 330 supplied into the cavity 110. That is, in the embodiment, the distribution of the layer thickness of the sealing resins 300 adsorbed on the adsorption unit 10 becomes generally uniform without depending on the average particle diameter of the multiple granular sealing resins 300. Furthermore, the distribution of the layer thickness of the multiple granular sealing resins 300 is generally uniform without depending on the layer thickness of the sealing resins 300.

According to the embodiment, since the adsorption unit 10 of the resin supply device 1 is formed of a block body or a plate, the area of the first main surface 10a of the adsorption unit 10 can be easily changed. Therefore, even if design of the size of the lower mold 100 and the upper mold 200 is changed, the resin supply device 1 fitted to the size of respective molds can be easily fabricated. Since the area of the adsorption unit 10 can be easily enlarged with enlarging area of the main surface, the resin sealing over a broad area is possible.

According to the embodiment, there exists no manufacturing process of pre-molding the multiple granular sealing resins 300 on the lower mold 100. Thus, an unnecessary thermal history is not left on the mold resin 300A of the semiconductor device 500. Therefore, the characteristics of the mold resin 300A of the semiconductor device 500 are hard to change for a long time.

In the embodiment, the granular sealing resins 300 in a range of an average particle diameter from 300 μm to 500 μm (range of average particle diameter of 300 μm or more, 500 μm or less) are used. If the average particle diameter of the granular sealing resin 300 is smaller than 300 μm, fine resin particles may be powder dust to soar around the resin mold device and contaminate the resin mold device. Alternatively, the granular sealing resins 300 adhere mutually and the layer thickness may be unable to be controlled precisely. If the average particle diameter of the granular sealing resins 300 is larger than 500 μm, the fluctuation of the layer thickness of the granular sealing resins 300 becomes large, and the sealing resins 300 may be unable to be supplied uniformly into the cavity of the lower mold 100. Alternatively, time for melting the granular sealing resins 300 becomes longer, and thus the takt time of manufacturing process of the semiconductor device may be longer.

### Second Embodiment

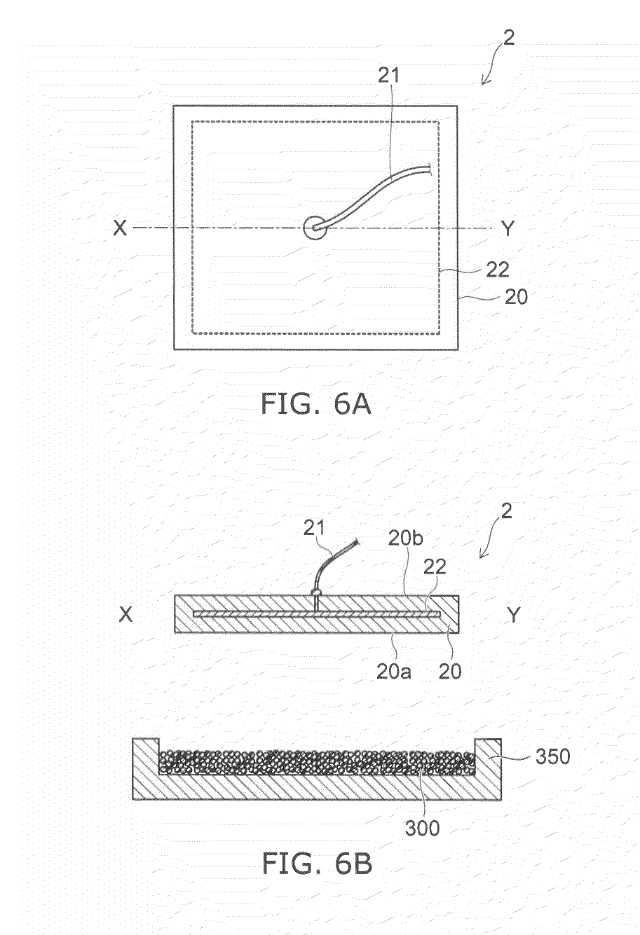

FIGS. 6A and 6B are schematic views of the relevant part of a resin supply device according to a second embodiment, FIG. 1A shows an upper surface schematic view of the relevant part, and FIG. 1B shows a cross-sectional view of the relevant part at an X-Y position in FIG. 6A. FIGS. 6A and 6B illustrate the vessel 350 with a resin supply device 2.

The resin supply device 2 includes an adsorption unit 20 and a power supply line 21 attached to the adsorption unit 20. A tabular electrode 22 is provided inside the adsorption unit 20. The electrode 22 is electrically connected to the power supply line 21. The adsorption unit 20 is a block body of a dielectric body or a plate of the dielectric body. A first major surface 10a and a second major surface 20a of the adsorption unit 20 are generally parallel. The first major surface 20a is an adsorption surface for the multiple granular sealing resins 300.

Material of the adsorption unit 20 includes, for example, silicon oxide, silicon carbide, alumina (Al₂O₃), glass or the like as main components. These sintered bodies are also included in the materials of the adsorption unit 20.

The power supply line 21 is, for example, connected to a direct power supply (not shown), and is capable of applying a positive potential (or negative potential) to the electrode 22 through the power supply line 21.

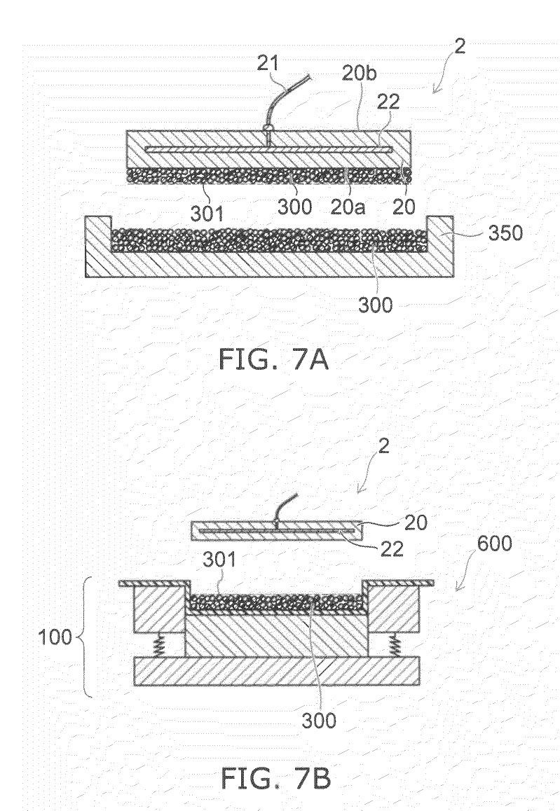

FIGS. 7A and 7B are views describing the operation of a resin supply device according to the second embodiment. As shown in FIG. 7A, if the positive potential (or negative potential) is applied to the electrode 22 of the adsorption unit 20, the adsorption unit 20 takes a charge. As a result, the multiple granular sealing resins 300 adsorb in a laminate on the first major surface 20a of the adsorption unit 20. That is, the resin supply device 2 can adsorb the multiple granular sealing resins 300 on the adsorption surface 20 by an electrostatic force. The granular sealing resins 300 adsorbed on the first major surface 20a of the adsorption unit 20 are not limited to a monolayer. For example, the multiple granular sealing resins 300 adsorb two-dimensionally in the first major surface 20a and furthermore adsorb three-dimensionally on the first major surface 20a. Thus, the adsorbed resin body 301 with a generally uniform thickness is formed on the first major surface 20a of the adsorption unit 20.

A distribution of the layer thickness on the first major surface 20a of the adsorbed sealing resins 300 does not depend on the average particle diameter of the multiple granular sealing resins 300 and is generally uniform. A distribution of the layer thickness on the first major surface 20a of the adsorbed sealing resins 300 does not depend on the layer thickness of the multiple granular sealing resins 300 and is generally uniform. The layer thickness of the adsorbed multiple granular sealing resins 300 is controlled by the amount of static charge electrical-charged on the adsorption unit 20. For example, with increasing static charge, a suction force by the adsorption surface increases, and the granular sealing resins 300 with a thicker thickness can be adsorbed on the adsorption surface.

Next, as shown in FIG. 7B, a ground potential is applied to the electrode 22 of the adsorption unit 20 to reduce the charge on the adsorption unit 20. Subsequently, the static force of the adsorption unit 20 is reduced. As a result, the sealing resins 300 which adsorbed on the first major surface 20a of the adsorption unit 20 drop directly into the cavity 110 under one's own weight. Since the layer thickness distribution of the sealing resins 300 adsorbed on the first major surface 20a of the adsorption unit 20 is generally uniform, the layer thickness of the sealing resins 300 supplied into the cavity 110 is generally uniform in the cavity 110. That is, the layer distribution of the supplied sealing resins 300 in the cavity 110 does not depend on the average particle diameter of the multiple granular sealing resins 300 and is generally uniform. The layer distribution of the supplied sealing resins 300 in the cavity 110 does not depend on the layer thickness of the multiple granular sealing resins 300 and is generally uniform. Even the resin supply device 2 can evenly supply the multiple granular sealing resins 300 into the cavity 110 of the lower mold 100. The semiconductor device 500 can be manufactured in the manufacturing process described in the first embodiment using the resin supply device 2. That is, also in the second embodiment, the same effect as the first embodiment is obtained.

### Third Embodiment

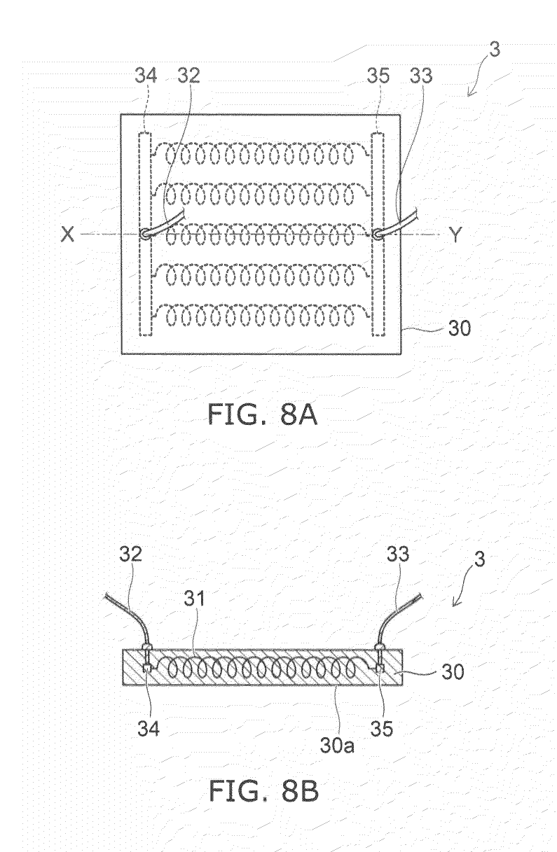

FIGS. 8A and 8B are schematic views of the relevant part of a resin supply device according to a second embodiment, FIG. 1A shows an upper surface schematic view of the relevant part, and FIG. 1B shows a cross-sectional view of the relevant part at an X-Y position in FIG. 8A.

A resin supply device 3 includes an adsorption unit 30, a power supply lines 32, 33 attached to the adsorption unit 30, a lead frame 34 connected to the power supply line 32, a lead frame 35 connected to the power supply line 33, and multiple coils 31 connected between the lead frames 34, 35. The lead frames 34, 35 and the coils 31 are provided inside the adsorption unit 30. The adsorption unit 30 is a block body or plate of the above dielectric body or the like.

The power supply lines 32, 33 are, for example, connected to the direct power supply (not shown), and a current can be energized to the coils 31 through the lead frames. This generates an electric field from the coils 31. The layer thickness of the multiple granular sealing resins 300 which are adsorbed on a first major surface 30a being the adsorption surface is controlled by current amount energized to the adsorption unit 30. For example, with increasing current amount, a suction force by the adsorption surface increases and the granular sealing resins 300 with a thicker layer thickness can adsorb on the adsorption surface.

Even the resin supply device 3 can cause the multiple granular sealing resins 300 to be adsorbed on the first major surface 30a as well as the resin supply devices 1, 2. That is, also in the third embodiment, the same effect as the first and second embodiments is obtained.

The embodiment of the invention has been described with reference to the examples. However, the invention is not limited to these examples. Those skilled in the art can suitably modify these specific examples by addition, deletion, or design change of components, or by addition, omission, or condition change of processes, and such modifications are also encompassed within the scope of the invention as long as they fall within the spirit of the invention. Furthermore, respective elements and its arrangement, material, condition, shape and size or the like included in the respective specific examples described above are not limited to illustrated ones and can be suitably modified. For example, the embodiment illustrates a manufacturing process of sealing the semiconductor chip with the resin, however the embodiment is not limited thereto. The resin supply devices 1, 2, 3 can be also used for the case of sealing other electronic parts other than the semiconductor chip with the resin. The resin sealing resins 300 may be a thermoplastic resin.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A resin supply device configured to supply granular resins to a resin mold device including a first mold provided with a cavity and a second mold mated to the first mold, the resin supply device comprising:
a first mechanism configured to juxtapose multiple granular resins on an adsorption surface by adsorbing the multiple granular resins on the adsorption surface larger than the granular resins, and form an adsorbed resin body with a uniform thickness, the adsorbed resin body made of the adsorbed multiple granular resins on the adsorption surface; and
a second mechanism configured to drop the multiple granular resins adsorbed on the adsorption surface into the cavity by adsorption-release of the adsorption surface.

2. The device according to claim 1, wherein an average particle diameter of the granular resins is in a range from 300 micrometers to 500 micrometers.

3. The device according to claim 1, wherein the multiple granular resins are adsorbed on the adsorption surface by vacuum-adsorption.

4. The device according to claim 1, wherein the multiple granular resins are adsorbed on the adsorption surface by an electrostatic force.

5. The device according to claim 1, wherein the adsorption surface is a surface of one of a porous block body and a porous plate.

6. The device according to claim 5, wherein a width of respective apertures of the porous body is smaller than the average particle diameter of the granular resins.

7. The device according to claim 5, wherein a width of respective apertures of the porous body is 150 micrometers or less.

8. The device according to claim 5, wherein the porous body is made of one of porous ceramic, activated charcoal, glass fiber, paper, cloth and foam polystyrene.

9. The device according to claim 1, wherein the adsorption surface is a surface of one of a block body of a dielectric body and a plate of the dielectric body.

10. The device according to claim 9, wherein a tabular electrode is provided inside the dielectric body.

11. A method for manufacturing a semiconductor device using a resin mold device including a first mold provided with a cavity and a second mold mated to the first mold, the method comprising:
juxtaposing multiple granular resins on an adsorption surface by adsorbing the multiple granular resins on the adsorption surface of a resin supply device, and forming an adsorbed resin body with a uniform thickness, the adsorbed resin body made of the adsorbed multiple granular resins on the adsorption surface;
opposing the first mold to the adsorption unit to drop the multiple granular resins into the cavity of the first mold by adsorption-release of the adsorption surface; and
after melting the multiple granular resins, mating the second mold to the first mold to immerse semiconductor chips attached to the second mold into the melted granular resins,
the resin supply device configured to supply the granular resins to the resin mold device,
the resin supply device including:
a first mechanism configured to juxtapose the multiple granular resins on the adsorption surface by adsorbing the multiple granular resins on the adsorption surface larger than the granular resins, and form the adsorbed resin body with the uniform thickness, the adsorbed resin body made of the adsorbed multiple granular resins on the adsorption surface;
a second mechanism configured to drop the multiple granular resins adsorbed on the adsorption surface into the cavity by the adsorption-release of the adsorption surface.

12. The method according to claim 11, wherein the granular resins are used, and the granular resins have an average particle diameter in a range from 300 micrometers to 500 micrometers.

13. The method according to claim 11, wherein the multiple granular resins are adsorbed on the adsorption surface by vacuum-adsorption.

14. The method according to claim 11, wherein the multiple granular resins are adsorbed on the adsorption surface by an electrostatic force.

15. The method according to claim 11, wherein the adsorption surface is a surface of one of a porous block body and a porous plate.

16. The method according to claim 15, wherein a width of respective apertures of the porous body is smaller than the average particle diameter of the granular resins.

17. The method according to claim 15, wherein a width of respective apertures of the porous body is 150 micrometers or less.

18. The method according to claim 15, wherein the porous body is made of one of porous ceramic, activated charcoal, glass fiber, paper, cloth and foam polystyrene.

19. The method according to claim 11, wherein the adsorption surface is a surface of one of a block body of a dielectric body and a plate of the dielectric body.

20. The method according to claim 19, wherein a tabular electrode is provided inside the dielectric body.
